(19) United States
(12) Patent Application Publication
(10) Pub. No.: US 2024/0343531 A1
(43) Pub. Date: Oct. 17, 2024

(54) MOBILE CRANE WITH A COUNTERWEIGHT DEVICE, COUNTERWEIGHT DEVICE AND METHOD FOR ASSEMBLING SUCH

(71) Applicant: Liebnerr-Werk Ehingen GbmH, Ehingen/Donau (DE)

(72) Inventors: Lars EBERHARDT, Staig (DE); Bernd BOOS, Mehrstetten (DE)

(21) Appl. No.: 18/634,315

(22) Filed: Apr. 12, 2024

(30) Foreign Application Priority Data
Apr. 17, 2023 (DE) 10 2023 109 566.8

(51) Int. Cl. B66C 23/36; B66C 23/74

(52) U.S. Cl. CPC B66C 23/74; B66C 23/36; B66C 2700/0378

(57) ABSTRACT

The disclosure relates to a mobile crane comprising a mobile undercarriage, an upper carriage mounted rotatably on the undercarriage and a counterweight device that can be coupled to the upper carriage and has a counterweight base plate, a carrier plate and at least two suspension weights that can be releasably connected to the carrier plate, wherein the carrier plate can be placed on the counterweight base plate and comprises first connecting elements for producing a first suspension connection with first connecting elements of the suspension weights. According to the disclosure, the carrier plate and the suspension weights are designed as a jointly liftable assembly unit, wherein the suspension weights have slinging means for lifting the entire assembly unit. The carrier plate comprises second connecting elements for establishing a second connection with second connecting elements of the suspension weights.

### CROSS REFERENCE TO RELATED APPLICATION

The present application claims priority to German Patent Application No. 10 2023 109 566.8 filed on Apr. 17, 2023. The entire contents of the above-listed application are hereby incorporated by reference for all purposes.

### TECHNICAL FIELD

The present disclosure relates to a mobile.

### BACKGROUND

Mobile cranes typically have an undercarriage with a wheeled or crawler chassis, an upper carriage mounted on the undercarriage so that it can rotate about a vertical axis, a boom (e.g. a telescopic boom or lattice tower boom) attached to the upper carriage so that it can pivot, and a counterweight device also known as an upper carriage ballast. In every position of the upper carriage, the counterweight applies a counter-torque to the load torque via a lever arm and therefore rotates with the upper carriage.

### SUMMARY

While smaller mobile cranes often carry all equipment for use on the construction site as so-called taxi cranes, even on public roads, larger mobile cranes are not able to do this, making it necessary to dismantle crane components and in particular the whole or part of the counterweight device for transport on public roads and to assemble them on site. The counterweight device on crawler cranes also typically has to be dismantled for transport and fitted to the upper carriage at the place of use.

It is therefore known from the prior art to provide a carrier plate or a counterweight base plate with coupling elements for detachable connection to the upper carriage, on which a plurality of counterweight elements can be stacked. For this purpose, the upper carriage is equipped with a ballasting device in the rear area that is able to pick up the counterweight device comprising the counterweight base plate and the counterweight elements stacked on it at the connecting elements from the floor or from a storage area on the undercarriage and lift it to the upper carriage for assembly. For disassembly, the counterweight base plate with the counterweight elements can be placed back on the floor or the undercarriage. For this purpose, the ballasting device usually comprises one or more hydraulic ballasting cylinders that extend downwards, are brought into engagement with the coupling elements of the counterweight device and lift the counterweight device onto the upper carriage by retracting. Counterweight devices with ballasting cylinders that extend upwards are also known.

The counterweights are often filled box constructions. A box contains all the necessary connecting elements and internal bracing to absorb the forces. In addition, suspension weights are known that have receptacles for suspension and bolting and can be suspended from the side of central counterweight plates in particular. An example of such suspension weights for use in counterweight devices for mobile cranes is known from DE 10 2020 123 821 B3. Suspension weights of this type can be suspended in one or two lifts on each side and have corresponding slinging means on which they can be picked up and lifted using a chain or rope.

The advantage of such suspension weights is that they do not increase the turning radius of the upper carriage on the construction site and their additional mass improves the stability torque when the load is picked up on the boom to prevent it from tipping in the load direction. However, the additional number of lifts required to bring the individual suspension weights into a set-up position is a disadvantage. The set-up position is understood here as a position in which the ballasting device of the mobile crane can reach the counterweight device assembled in its final state and mount it on the upper carriage in the rear area, i.e. on the side of the upper carriage opposite the boom. Each additional lift of counterweight elements takes time and extends the set-up time of the counterweight device or the time required to bring the mobile crane into working condition. Furthermore, each additional lift and the attachment of the suspension weights is associated with an additional risk of an avoidable work step.

The object of the present disclosure is therefore to provide a counterweight device for generic mobile cranes that can be set up quickly and safely.

According to the disclosure, this object is achieved by a mobile crane, a counterweight device and an assembly method as described herein.

Accordingly, a mobile crane is proposed that comprises a mobile undercarriage, an upper carriage rotatably mounted on the undercarriage and a counterweight device that can be coupled to the upper carriage. More particularly, a boom, for example a telescopic boom, is articulated to the upper carriage in a luffing manner. The counterweight device comprises a counterweight base plate, a carrier plate and at least two suspension weights that can be detachably connected to the carrier plate. The carrier plate can either be placed directly, i.e. directly on the counterweight base plate, or it can be placed indirectly on the counterweight base plate (i.e. in this case, further counterweight elements can be stacked on the counterweight base plate, on which the carrier plate can in turn be placed). The carrier plate further comprises first connecting elements for establishing a first suspension connection with first connecting elements of the suspension weights.

According to the disclosure, the carrier plate and the suspension weights are designed as an assembly unit (hereinafter also referred to as the first or upper assembly unit) that can be lifted together. The carrier plate and the suspension weights therefore do not have to be lifted individually and assembled on the mobile crane, but can be transported in the assembled state (for example on a separate transport vehicle) and lifted together in the assembled state and placed on the counterweight base plate. This eliminates the additional lifts for the suspension weights on the construction site and the need to hook them into the corresponding suspension connections on site, which significantly reduces the set-up time and increases safety during set-up.

The assembly unit can be put together once before use on the construction site and does not have to be separated afterwards either during transport or when setting up the mobile crane. The assembly unit can remain assembled until the carrier plate is to be used for a specific application—without the suspension counterweights, for example. For this purpose, the carrier plate optionally also has corresponding slinging means so that it can be lifted individually.

Further precautions must be taken to ensure that the carrier plate can be lifted together with the suspension weights. With normal suspension connections, such as those known from DE 10 2020 123 821 B3, there would otherwise be a risk of one of the suspension weights detaching from the carrier plate when the assembly unit is lifted.

For this reason, according to the disclosure, the carrier plate and the suspension weights comprise not only the first connection means for forming the suspension connection, but furthermore second connection means which form a second connection, in particular after the first suspension connection has been formed. In addition, the assembly unit can be lifted using the lateral suspension weights according to the disclosure. For this purpose, the suspension weights have corresponding slinging means to which a rope or chain of a hoist can be attached. The second connection means are designed in such a way that, together with the first connection means, they can transmit the high forces that arise during the lift due to the weight of the carrier plate.

This allows the assembly unit to be lifted by the suspension weights, in particular via the boom of the mobile crane itself, and the counterweight device to be assembled or set up so that it can then be lifted onto the upper carriage by a ballasting device.

The second connection also serves to secure the first suspension connection. According to the disclosure, the second connection is therefore designed in such a way that when the assembly unit is lifted over the suspension weights, the first suspension connection of the respective suspension weight is blocked or prevented from coming loose. This is not only a factor that significantly increases safety when moving the assembly unit, but also during crane operation when the counterweight device is attached to the upper carriage. Any problem cases must also be taken into account. These can be, for example, a tear-off of the load on the boom, which typically releases very large forces. No avoidable risks may occur in this case either. These forces can also accelerate very heavy elements, such as the suspended suspension weights, upwards against their gravity and release them from their abutments or connections. The safety function of the second connection means that the suspension connections cannot come loose even in such problematic cases.

The counterweight base plate and/or the carrier plate and/or the suspension weights can be made of grey cast iron or designed as a filled box construction.

In one possible embodiment, it is provided that the upper carriage comprises a ballasting device that is configured to lift the counterweight device from a storage area of the lower carriage and deposit it on the latter.

Optionally, the ballasting device comprises at least one hydraulic ballasting cylinder, which in particular can be extended downwards in the direction of the set-up counterweight device and can be coupled to it. By subsequently inserting the at least one ballasting cylinder, the counterweight device can be lifted from the storage area on the undercarriage and moved to the upper carriage, where the counterweight device can be connected to the upper carriage in particular, for example via bolt connections.

Optionally, the ballasting device comprises a ballast frame that can be connected (in particular, bolted) to the upper carriage and can be moved by the ballasting cylinder(s). Alternatively or additionally, the ballast frame can comprise a winch structure, which can be detachably attached to the ballast frame, for example. The ballast frame can be detachably connected to the frame structure of the upper carriage via corresponding fastening elements, such as bolt receptacles and bolts, so that it can also be removed from the upper carriage for transport.

In another possible embodiment, it is provided that the counterweight device comprises at least one coupling element extending substantially perpendicular to the counterweight base plate and connected thereto for lifting and coupling the counterweight device to the upper carriage. The carrier plate may comprise at least one recess through which the at least one coupling element protrudes in the deposited state. The carrier plate is thus “threaded” onto the at least one coupling element when it is placed on the counterweight base plate (or another counterweight element stacked on it). In particular, the at least one coupling element represents a traction element and fastening element for the entire counterweight device in one, which reduces the number of components, facilitates operation or assembly and ensures a stable connection of the various components. The at least one coupling element can be designed in one piece. This eliminates the need for complex welded joints with other components, which simplifies the manufacturing process.

In another possible embodiment, it is provided the at least one coupling element has a coupling portion at an end opposite the counterweight base plate, via which a coupling to the ballasting device, in particular to a ballasting cylinder, can be established. Said ballasting cylinder can have a piston rod that can be extended downwards from the ballasting device and coupled to the coupling portion of the coupling element. Two or more ballasting cylinders and a corresponding number of coupling elements may be provided.

In another possible embodiment, it is provided that the coupling portion comprises a receptacle, into which a coupling piece of a ballasting cylinder can be inserted, in particular by rotating the upper carriage about its axis of rotation. The coupling piece can be part of the piston rod of the ballasting cylinder or a component connected to it. The recess of the coupling portion can be designed in a known manner such that it allows the ballasting cylinder to be pushed in sideways (e.g. following a circular movement) and, when in the coupled state, blocks movement of the ballasting cylinder out of the recess in a vertical direction in a form-fitting manner.

In a further possible embodiment, it is provided that the counterweight device comprises a further counterweight element that can be stacked on the counterweight base plate and that has at least one recess through which the aforementioned at least one coupling element protrudes in the deposited state. The additional counterweight element is arranged between the counterweight base plate and the carrier plate in the set-up state. If there is only one other counterweight element, the carrier plate rests directly on it. If a plurality of further counterweight elements is provided, the carrier plate rests in particular on the uppermost or on the at least one coupling element.

The counterweight base plate and the at least one further counterweight element may also form an assembly unit (hereinafter also referred to as the second or lower assembly unit) that can be lifted together. This further reduces the number of lifts required for set-up. This assembly unit can, for example, be transported separately from the mobile crane and lifted together onto a storage area on the undercarriage of the mobile crane for set-up, for example by the boom of the mobile crane itself.

The various assembly units can be designed with regard to their total weight so that they can be transported cost-effectively on public roads. One of the assembly units or both assembly units can, for example, weigh approx. 20 tons (or less), wherein other values are of course also possible depending on the country and requirements.

In a further possible embodiment, it is provided that the at least one coupling element comprises a centering means by means of which the counterweight device can be positioned on the upper carriage in an assembly position. In particular, the centering means interacts with a counter-centering means on the upper carriage and ensures automatic positioning of the counterweight device during lifting to the upper carriage. Centering the counterweight device in a designated assembly position on the upper carriage makes it easier to attach.

The upper carriage may have a corresponding counter-centering means that, when the counterweight device is lifted, is designed to automatically position the counterweight device in an assembly position in which it can be connected to the upper carriage, in particular the aforementioned ballasting device, by interacting with the centering means of the coupling element. Optionally, the centering means is designed as an element extending essentially in the longitudinal direction of the coupling element, e.g. as a projection. The counter-centering means accordingly forms a recess into which the centering means moves when the counterweight device is lifted. However, the opposite (centering means as a recess and counter-centering means as a projection projecting downwards from the upper carriage or similar) is also conceivable. The centering means may comprise at least one beveled surface or chamfer, i.e. it can have one or more beveled surfaces, for example in one or two directions, to make it easier for the centering means and counter-centering means to engage with one another. A conical shape with a circumferential chamfer of the centering device or counter-centering device is also possible.

Alternatively or additionally, the at least one coupling element can comprise a fastening means via which the counterweight device can be releasably connected to the upper carriage in an assembly position (in particular the assembly position achieved by the aforementioned pre-centering). The counterweight device is therefore in particular not held on the upper carriage by one or more ballasting cylinders during crane operation, but a separate connection is provided, which is established via the fastening means of the at least one coupling element and in particular via corresponding connection means on the upper carriage. This allows the counterweight device, including the carrier plate and suspension weights, to be securely and stably attached to the upper carriage so that the ballast cylinders are relieved.

In another possible embodiment, it is provided that the second connections form axes of rotation for the suspension weights and are thus designed such that the suspension weights pivot about the axes of rotation relative to the carrier plate when the assembly unit is lifted. Due to the high weight of the carrier plate arranged in the center, the laterally arranged suspension weights spread apart laterally by a defined distance when lifted. This rotating or spreading movement is optionally limited by a stop of the first connecting elements. In order for this rotating or spreading movement to be possible, the first connecting elements must be designed accordingly and allow a certain degree of mobility even when connected.

Spreading out increases the distance between the suspension weights by a defined distance, so that the assembly unit forms a wider receiving area or a wider recess for the counterweight base plate when spread out and can therefore be placed on it more easily. When being deposited, the suspension weights are located in particular next to the counterweight base plate and pivot towards it due to their own weight.

This targeted spreading movement of the suspension weights during lifting makes it easier to place the assembly unit consisting of the carrier plate and suspension weights on the counterweight base plate (or any other counterweight elements placed on it).

In a further possible embodiment, it is provided that the first connecting elements comprise suspension bolts arranged on the carrier plate and hook elements arranged on the suspension weights, wherein the latter are hooked into the suspension bolts in order to anchor the suspension weights to the carrier plate. The hook elements comprise a recess that is open to one side and may have a greater width than the suspension bolt accommodated therein in order to enable the above-mentioned spreading movement due to this defined play. The stop of the first connecting elements, which limits the spreading movement, may be formed by the aforementioned hook elements and suspension bolts. Instead of the hook connection described above, plugged bolt connections can also be used.

Alternatively or additionally, it can be provided that the recesses of the hook elements widen towards their openings, making it easier to insert the suspension bolts.

In a further possible embodiment, it is provided that the carrier plate has cavities, in particular on the sides or at the corners, within which the first and second connecting elements are arranged in such a way that they do not protrude beyond the outer contour of the carrier plate in plan view. This does not increase the overall width of the carrier plate, in particular if it is used without suspension weights. The cavities can be formed by surrounding sheets of the carrier plate in the event that this is designed as a filled sheet metal box construction.

In another possible embodiment, it is provided that the counterweight device is designed such that in the set-down state of the carrier plate the suspension weights connected thereto are arranged laterally next to the counterweight base plate. In particular, the suspension weights can have a height that corresponds to the total height of the counterweight package comprising the counterweight base plate, any other counterweight elements and the carrier plate. However, it is of course also possible for the suspension weights to have a lower height or to protrude upwards beyond the carrier plate.

More than one coupling element may be provided for stable mounting and fastening of the counterweight device on the upper carriage. In a further possible embodiment, the counterweight device therefore comprises at least two spaced-apart coupling elements connected to the counterweight base plate. Exactly two coupling elements can be provided, or even more than two coupling elements. The coupling elements may have a flat shape.

Optionally, the coupling elements are arranged at the same distance from the center of gravity or from a center line of the counterweight base plate (which may be aligned parallel to the longitudinal axis of the upper carriage). This can result in an axially symmetrical arrangement of the counterweight base plate and coupling elements.

Alternatively or additionally, the coupling elements can be arranged rotated relative to each other (each around a vertical axis), i.e. their coupling portions do not point exactly towards each other. This may be due to the fact that the ballast cylinders are moved on a circular path by rotating the upper carriage in order to establish the coupling with the coupling elements. Optionally, however, the coupling elements are not rotated relative to each other, but are arranged parallel to each other. This simplifies the manufacture of the counterweight base plate and any counterweight elements that can be stacked on it.

Optionally, the counterweight base plate including the coupling element(s) and/or the carrier plate has an axisymmetrical structure with respect to a center axis running through the center of the counterweight device.

The present disclosure also relates to a counterweight device for a mobile crane according to the disclosure. This obviously results in the same advantages and properties as for the mobile crane according to the disclosure, which is why a repetitive description is dispensed with. Optionally, the counterweight device comprises at least one further counterweight element, which can be placed or stacked on the counterweight base plate. The counterweight element may have at least one recess for the passage of the at least one coupling element.

The disclosure also relates to a method for assembling the counterweight device according to the disclosure on the upper carriage of a mobile crane according to the disclosure.

The method comprises at least the following steps:
placing the counterweight base plate on a storage area of the undercarriage, in particular by means of a boom of the mobile crane,
lifting the assembly unit consisting of the carrier plate and the suspension weights connected to it via slinging means of the suspension weights,
depositing the assembly unit on the counterweight base plate, wherein the assembly unit is deposited in particular either directly on the counterweight base plate or on another counterweight element stacked on top of it,
lifting the entire counterweight device via a ballasting device of the mobile crane to the upper carriage, in particular by coupling at least one ballasting cylinder to at least one coupling element connected to the counterweight base plate and projecting through the carrier plate.

This obviously results in the same advantages and properties as for the mobile crane according to the disclosure, which is why a repetitive description is dispensed with. In particular, reference is made to the possible embodiments and optional features discussed in the context of the mobile crane according to the disclosure, which apply analogously to the method according to the disclosure.

In one possible embodiment of the method, it is provided that the first and second connections are formed as described above and the second connecting elements form an axis of rotation about which the suspension weights pivot relative to the carrier plate during lifting. When the assembly unit is lifted, the suspension weights therefore spread apart laterally as described above, so that the assembly unit forms a widened receiving area for the counterweight base plate when spread out and can be set down on it. When being deposited, the suspension weights may be positioned next to the counterweight base plate and pivot towards it.

### BRIEF DESCRIPTION OF THE FIGURES

Further features, details and advantages of the disclosure result from the following exemplary embodiments explained with the help of the figures. In the drawings:

FIG. 1: shows a side view of the mobile crane according to the disclosure according to an exemplary embodiment;

FIG. 2: shows the counterweight device according to the disclosure during set-up with a view of its rear side;

FIG. 3: shows the counterweight device in the set-up state with a view of its rear side;

FIG. 4: shows a plan view of the counterweight device in the set-up state;

FIG. 5: shows a plan view of an enlarged section of the connection area of a suspension weight;

FIG. 6: shows a side view of the connection area according to FIG. 5; and

FIG. 7: shows the set-up counterweight device 10 with the attached assembly unit 11 being lifted by means of sling ropes with a view of its rear side.

### DETAILED DESCRIPTION

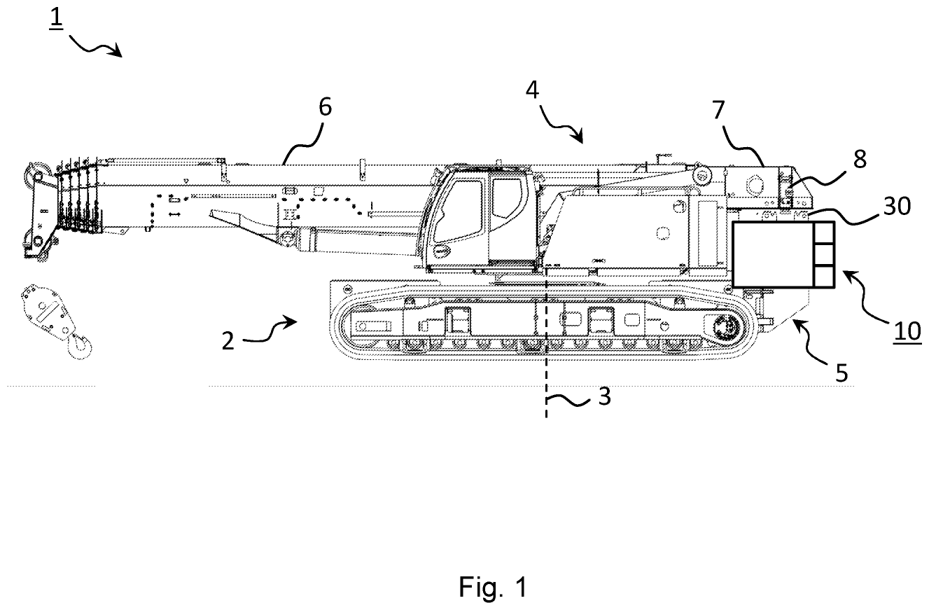

FIG. 1 shows a side view of an exemplary embodiment of the mobile crane 1 according to the disclosure in the form of a crawler crane. The mobile crane 1 has an undercarriage 2 with a crawler chassis and an upper carriage 4 mounted on the undercarriage 2 so that it can rotate about a vertical axis of rotation 3. The upper carriage 4 comprises a telescopic boom 6 mounted to luff about a horizontal axis and a counterweight arrangement also referred to as upper carriage ballast.

In this exemplary embodiment, the upper carriage ballast comprises a ballast frame 7, which is connected to the steel structure of the upper carriage 4 via bolt connections and can be removed from the upper carriage 4 for transport. Two hydraulic ballasting cylinders 8 are mounted on the ballast frame 7, the piston rods of which can be extended downwards and each have a coupling piece. A counterweight device 10 can be lifted from a storage area 5 to the upper carriage 4 via the ballasting cylinders 8 and connected to it. Conversely, the counterweight device 10 can be placed back on the storage area 5 by extending the ballasting cylinders 8 and loaded from there onto a transport vehicle using an auxiliary crane or the boom 6 of the mobile crane 1.

In this exemplary embodiment, the storage area 5 is formed by a hinged storage device at the rear of the undercarriage 2, which comprises two pivoting hinged parts on which the counterweight device 10 can be stored. However, the storage area could also be located on the top of the undercarriage 2 or on the floor, for example.

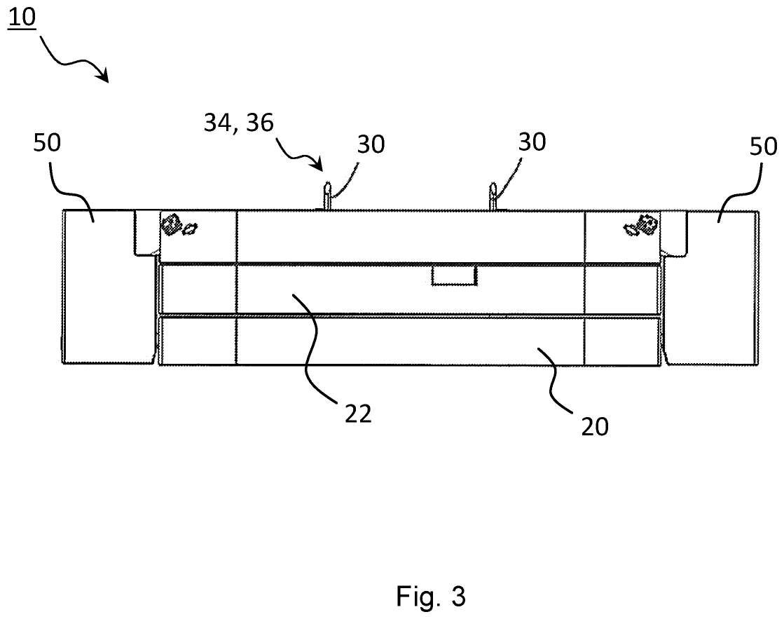

The counterweight device 10 comprises a counterweight base plate 20, on which one or more plate-shaped counterweight elements 22 can be stacked. In addition, a plurality of suspension weights 50 is provided, which are described below. This allows the upper carriage ballast to be configured variably and adapted to the desired application. In the exemplary embodiment shown here, a single further counterweight plate 22 is provided (apart from the carrier plate 40 described later). A side view looking at the rear of the counterweight device 10 is shown in FIG. 3.

The counterweight device 10 is coupled to the ballasting cylinders 8 via coupling elements 30 projecting vertically upwards from the counterweight base plate 20, which have coupling portions 32 at their upper ends for reversible coupling to the coupling pieces of the ballasting cylinders 8 as well as fastening means 36 for fastening the counterweight device 10 to the ballast frame 7. The alignment or positioning of the counterweight device 10 in an assembly position on the ballast frame 7 to establish the connection via the fastening means 36 is carried out via centering means 34 of the coupling elements 30. The centering means 34 and fastening means 36 can be seen in a side view in FIG. 1 (these protrude above the top plate or carrier plate 40 of the counterweight device 10).

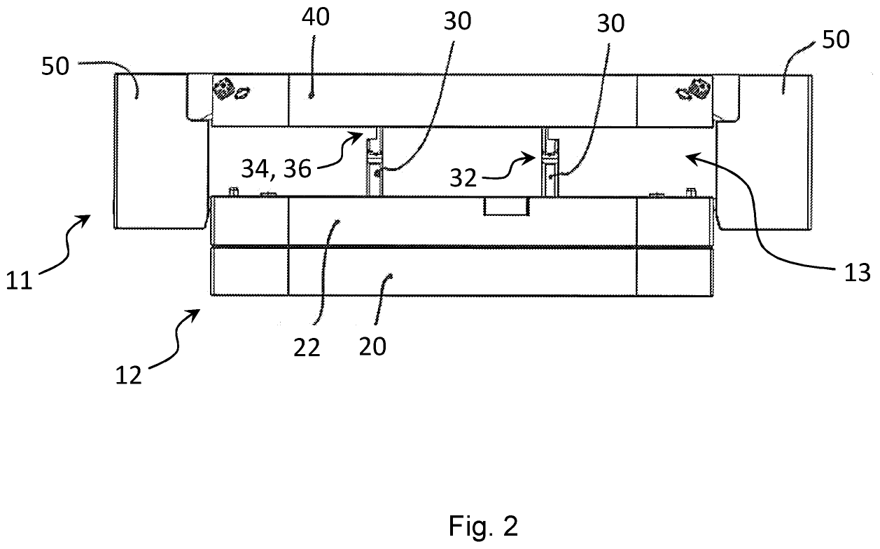

As can be seen in FIG. 2, which shows the counterweight device 10 being set up with a view of its rear side, the counterweight device 10 comprises a carrier plate 40 that forms the upper end of the ballast stack comprising the counterweight base plate 20 and the further counterweight element 22. Additional counterweight elements in the form of suspension weights 50 are attached to the side of the carrier plate 40, in the exemplary embodiment discussed here one suspension weight 50 per side.

The suspension weights 50 are arranged such that they extend to the lower counterweight base plate 20 when the counterweight device 10 is fully assembled (i.e. set up). In particular, the height of the suspension weights 50 corresponds to the height of the ballast stack of the counterweight device 10.

According to the disclosure, the carrier plate 40 and the suspension weights 50 form a common (first) assembly unit 11, which can be transported and lifted together (in this respect, it can also be referred to as a transport and assembly unit 11). This means that only a single stroke is required to lift the carrier plate 40 and suspension weights 50 to the storage area 5.

The counterweight base plate 20 and the further counterweight element 22 placed thereon optionally also form a common (second) assembly unit 12. For this purpose, the coupling elements 30 can have slinging means (not shown here) (for example in the form of corresponding recesses to which chains or ropes can be attached) in order to be able to lift the lower or second assembly unit 12 via the coupling elements 30.

A possible exemplary embodiment of a storage device 5 of the undercarriage 2 is shown in FIG. 1. The central ballast, which can be assembled directly on the undercarriage 2 via fastening elements, is extended by a hinged holder for the counterweight device 10. Two pivot parts are hinged to the side cheeks of the central ballast and have support surfaces on their upper sides on which the counterweight device 10 can be placed.

To set up the counterweight device 10, the lower assembly unit 12, comprising the counterweight base plate 20 and the counterweight element 22 already placed on it, is first lifted from a transport vehicle (e.g. a low-loader) and placed on the storage area 5. The lift may be carried out by means of the boom 6 of the mobile crane 1 in self-set-up mode, but could of course also be carried out by an auxiliary crane.

The upper assembly unit 11, comprising the carrier plate 40 and suspension weights 50, which have also already been assembled and transported separately, is now set down on the lower assembly unit 12 (e.g., using the boom 6). The state shortly before setting down is shown in FIG. 2. It can be seen that the space between the suspension weights 50 and below the carrier plate 40 forms a receiving area 13 for the counterweight base plate 20 and counterweight element 22, in which the latter components are received in the set-up state (see FIG. 3).

As can be seen in FIG. 3, the coupling elements 30 connected to the counterweight base plate 20 have such a length that they protrude beyond the top of the carrier plate 40 in the set-up state. For this purpose, both the further counterweight element 22 and the carrier plate 40 have correspondingly shaped recesses through which the coupling elements 30 protrude. The coupling elements 30, which could also be referred to as connecting levers, are in particular one-piece sheet metal structures that have a flat basic shape and are connected to the counterweight base plate 20.

The directions “up” and “down” used here refer to the case where the counterweight base plate 20 (and the mobile crane 1) are standing on a level surface and the coupling elements 30 are aligned vertically.

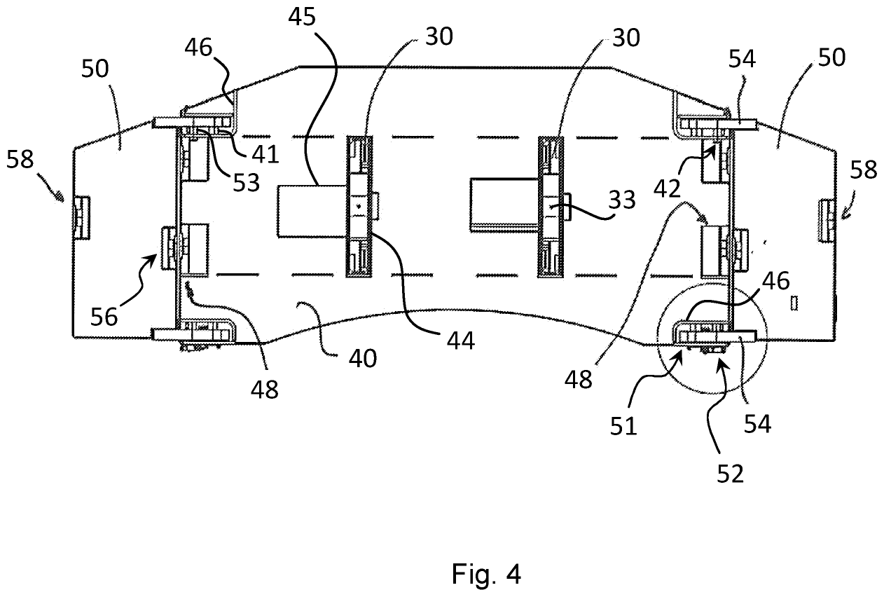

FIG. 4 shows a plan view of the carrier plate 40 with the suspension weights 50 attached to it. The essentially slot-shaped recesses 44, in which the coupling elements 30 are arranged, can be seen running parallel to one another.

The coupling elements 30 serve both to pick up and lift the counterweight device 10 and to center it on and attach it to the ballasting device (or to the ballast frame 7). For this purpose, the coupling elements 30 have a coupling portion 32 at their end opposite the counterweight base plate 20 (see FIG. 2).

The coupling portion 32 comprises, in particular, an upwardly open, clamp-shaped recess 33 (see FIG. 4), into which a specially shaped (in particular mushroom-shaped) end or coupling piece of the corresponding ballasting cylinder 8 can enter laterally. In the final position, in which the counterweight device 10 can be safely lifted, the coupling pieces of the ballasting cylinders 8 are located in the center of the respective recesses 33, which, thanks to their shape, enable the counterweight device 10 to be lifted in a form-fitting manner by retracting the ballasting cylinders 8.

In the exemplary embodiment shown here, the ballasting cylinders 8 are coupled to the coupling elements 30 by rotating the upper carriage 4 about its axis of rotation 3. For this reason, the recesses 44 are widened in the center area to one side (to the left in FIG. 4) so that the coupling pieces of the ballasting cylinders 8 next to the coupling elements 30 can be moved downwards into the widened portions 45 of the recesses 44 until the coupling pieces are at the level of the recesses 33. Coupling can then be established by rotating the upper carriage 4. In the exemplary embodiment shown here, the widened portions 45 have a rectangular shape and are arranged slightly offset from one another (i.e. not at the same height in plan view) in order to take into account the circular path of the ballasting cylinders 8 when the upper carriage 4 rotates. Other shapes and arrangements of the recesses 45 are also conceivable.

After lifting the counterweight device 10 to the upper carriage 4 or ballast frame 7, the coupling elements 30 are bolted to the ballast frame 7. This relieves the ballasting cylinders 8 during crane operation. Therefore, the coupling elements 30 have fastening means 36 in the area of the coupling portions 32 (see FIGS. 1 and 3), that enable a stable connection of the counterweight device 10 to the ballast frame 7. The fastening means 36 are in particular designed as bolt receptacles through which corresponding fastening bolts can be inserted in the assembly position.

The coupling elements 30 may also comprise centering means 34 in the area of the fastening means 36 (see FIGS. 1 and 3), in the exemplary embodiment shown here in the form of a projection or mandrel projecting upwards and tapering in the longitudinal direction of the coupling element 30, via which the counterweight device 10 is brought into the desired mounting position when the ballasting cylinders 8 are retracted. The centering means 34 interact with counter-centering means not shown on the ballast frame 7 and ensure that the counterweight device 10 is automatically aligned when it is moved towards the ballast frame 7.

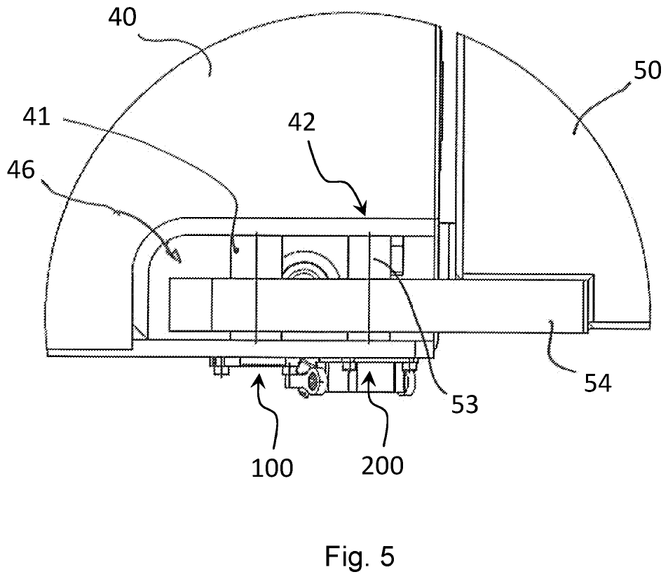

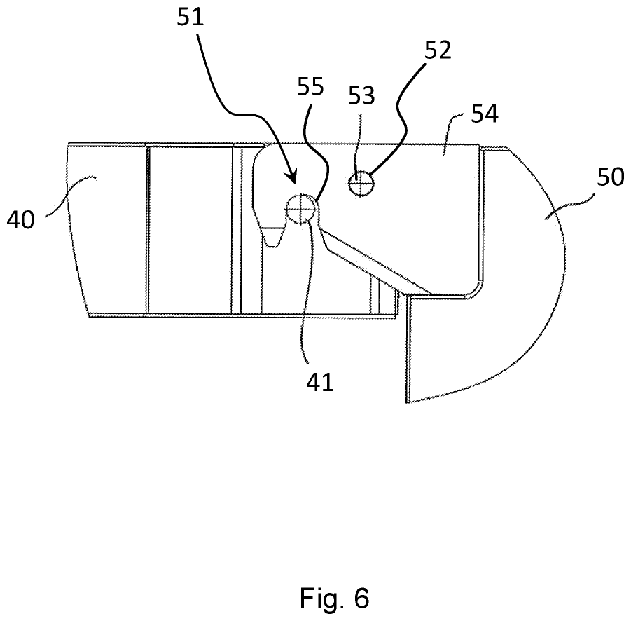

The suspension weights 50 are detachably attached to the carrier plate 40 via two connections 100, 200. A first suspension connection 100 is produced by means of first connecting elements 41, 51 and enables uncomplicated suspension of the suspension weights 50 on the carrier plate 40. For this purpose, the suspension weights 50 have lateral connecting plates 54 in the area of the end face facing the carrier plate 40, which form hook elements 51 in their front sections. The arrangement of the connecting plates 54 can be seen in the plan view of FIG. 4, while FIGS. 5 and 6 show a plan view and a side view of one of these connecting plates 54 in the connected state.

The hook elements 51 (=first connecting elements of the suspension weights 50) comprise downwardly open recesses 55, in which suspension bolts 41 (=first connecting elements of the carrier plate 40) are received, which are located in cavities 46 formed at the corners of the carrier plate 40 (see FIG. 4). The suspension weights 50 are hooked into the suspension bolts 41 of the carrier plate 40 via the hook elements 51, thereby forming the first suspension connections 100. In principle, it would also be conceivable to provide upwardly open hook elements on the carrier plate 40 and suspension bolts on the suspension weights 50.

In addition, the carrier plate 40 and the suspension weights 50 have second connecting elements 42, 52, 53 for forming a second connection 200, which secure the first suspension connection 100 and prevent unintentional unhooking of the suspension weights 50. In the exemplary embodiment shown here, the second connecting elements 42, 52, 53 comprise bolt receptacles 42 formed on the carrier plate 40 in the region of the cavities 46 and bolt receptacles 52 also formed on the connecting plates 54, through which corresponding bolts 53 are inserted as soon as the bolt receptacles 42, 52 overlap.

The cavities 46 are provided on the carrier plate 40 such that the connecting plates 54 do not protrude laterally beyond the outer contour of the carrier plate 40, i.e. the connecting plates 54 are located “inside” the cavities 46 in plan view.

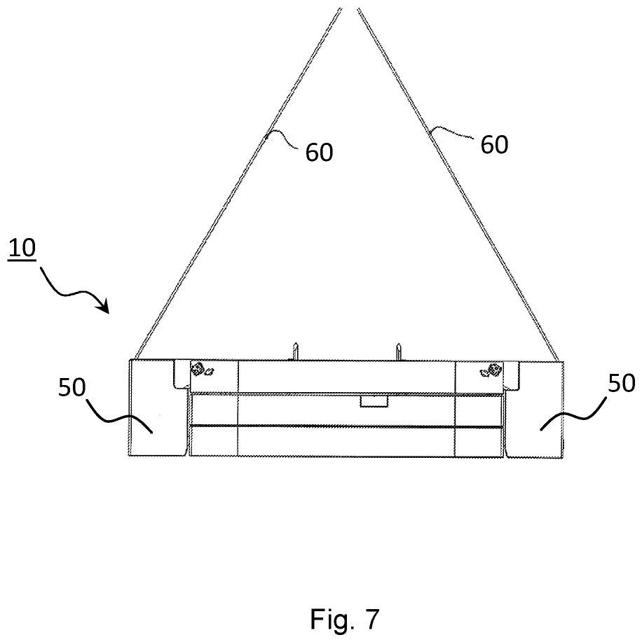

The second connections 200 or bolt connections not only increase safety when lifting the assembly unit 11 or during crane operation, for example in the event of a sudden load drop, but also enable the assembly unit 11 according to the disclosure to be lifted above the suspension weights 50, as shown in the side view of FIG. 7. For this purpose, the suspension weights 50 have corresponding slinging means 58 on their sides spaced apart from the carrier plate 40, to which a sling rope 60 or a sling chain of a hoist can be attached.

Without the second connections 200, the suspension connections 100 would simply come loose when the suspension weights 50 are lifted. The first and second connecting elements 41, 42, 51, 52, 53 are designed in such a way that they can safely absorb and transmit the forces occurring during the lift.

As can be seen in FIG. 6, the openings 55 of the hook elements 51 have a greater width than the suspension bolts 41 received therein. This defined clearance makes it easier to attach the suspension weights 50. A pivot movement is achieved by a larger bore 52

This deliberate pivot movement of the suspension weights 50 makes it easier to place the upper assembly unit 11 on the lower assembly unit 12 (see FIG. 2). During the lift of the assembly unit 11, the suspension weights 50 are pivoted apart or spread apart by a defined distance due to the mobility described above. This widens the receiving area 13 between the suspension weights 50, making it easier to insert the lower assembly unit 12 into this receiving area 13.

Since the carrier plate 40 can also be used for certain applications without the suspension weights 50, it also has corresponding slinging means 48 on its sides. In principle, the assembly unit 11 could also be lifted over these slinging means 48 of the carrier plate 40. In this case, however, the advantage of spreading the suspension weights 50 apart as described above would not arise.

The ballast elements 20, 22, 40, 50 can be designed either as a filled box construction or as a cast ballast. Optionally, however, said ballast elements 20, 22, 40, 50 are made of an inexpensive and environmentally friendly box construction into which, for example, metal parts are inserted during manufacture and the gaps are filled with a filling compound. However, these have a lower specific weight, meaning that an additional volume of counterweight is required for many applications in order to generate the necessary torque for stability. This additional weight is provided by the suspension weights 50.

Finally, it should be mentioned that operating personnel may be required to place the counterweight package formed by the assembly unit 11 on the already prepared counterweight package of the assembly unit 12 and to make the connections between them. These steps can be carried out from a comfortable and safe position on the undercarriage 2. It is only necessary to enter the exposed counterweight device 10 itself to unhook or hang the sling ropes 60. However, this does not usually require a great deal of effort. If climbing onto the counterweight device 10 is to be avoided altogether, folding ladders can be used, for example.

FIGS. 1-7 are drawn to scale, although other relative dimensions may be used, if desired.

### LIST OF REFERENCE NUMERALS

1 Mobile crane
2 Undercarriage
3 Axis of rotation
4 Upper carriage
5 Storage area
6 Boom
7 Ballast frame
8 Ballasting cylinder
10 Counterweight device
11 (Upper) assembly unit
12 Second (lower) assembly unit
13 Receiving area
20 Counterweight base plate
22 Counterweight element
30 Coupling element
32 Coupling portion
33 Receptacle
34 Centering means
36 Fastening means
40 Carrier plate
41 First connecting element (suspension bolt)
42 Second connecting element (bolt receptacle)
44 Recess
45 Widened portion of the recess
46 Cavity
48 Slinging means
50 Suspension weight
51 First connecting element (hook element)
52 Second connecting element (bolt receptacle)
53 Bolt
54 Connection plate
55 Recess
56 Slinging means
58 Slinging means
60 Sling part
100 First connection (suspension connection)
200 Second connection

1. Mobile crane comprising a mobile undercarriage, an upper carriage mounted rotatably on the undercarriage and a counterweight device that can be coupled to the upper carriage and has a counterweight base plate, a carrier plate and at least two suspension weights that can be releasably connected to the carrier plate, wherein the carrier plate can be placed on the counterweight base plate and comprises first connecting elements for producing a first suspension connection with first connecting elements of the suspension weights,
wherein
the carrier plate and the suspension weights are designed as a jointly liftable assembly unit and the suspension weights have slinging means for lifting the entire assembly unit, wherein the carrier plate comprises second connecting elements for establishing a second connection with second connecting elements of the suspension weights, which carrier plate is designed to block a release of the first suspension connection when the assembly unit is lifted over the suspension weights.

2. Mobile crane according to claim 1, wherein the upper carriage comprises a ballasting device, which is designed to lift the counterweight device from a storage area of the undercarriage and deposit it thereon.

3. Mobile crane according to claim 2, wherein the counterweight device comprises at least one coupling element extending substantially perpendicular to the counterweight base plate and connected thereto for lifting and coupling the counterweight device to the upper carriage.

4. Mobile crane according to claim 3, wherein the at least one coupling element has a coupling portion at an end opposite the counterweight base plate, via which a coupling to the ballasting device, to a ballasting cylinder of the ballasting device, can be established.

5. Mobile crane according to claim 4, wherein the coupling portion comprises a receptacle, into which a coupling piece of a ballasting cylinder can be inserted.

6. Mobile crane according to claim 3, further comprising at least one further counterweight element that can be stacked on the counterweight base plate and that has at least one recess through which the at least one coupling element projects in the deposited state, wherein the further counterweight element is arranged between the counterweight base plate and the carrier plate in the ballasted state,.

7. Mobile crane according to claim 3, wherein the at least one coupling element comprises a centering means, by means of which the counterweight device can be automatically positioned in an assembly position when it is lifted on the upper carriage, and/or a fastening means, by means of which the counterweight device can be releasably connected to the upper carriage in an assembly position and which has a bolt receptacle for producing a bolt connection to the upper carriage.

8. Mobile crane according to claim 1, wherein the second connections form axes of rotation for the suspension weights and are thus designed such that the suspension weights pivot about the axes of rotation relative to the carrier plate when the assembly unit is lifted and thus spread apart laterally by a defined distance.

9. Mobile crane according to claim 1, wherein the first connecting element comprise suspension bolts arranged on the carrier plate and hook elements arranged on the suspension weights, wherein the hook elements comprise a recess open to one side.

10. Mobile crane according to claim 1, wherein the carrier plate has cavities within which the first and second connecting elements are arranged in such a way that they do not project beyond the outer contour of the carrier plate in plan view.

11. Mobile crane according to claim 1, wherein the counterweight device is designed such that in the set-down state of the carrier plate the suspension weights connected thereto are arranged laterally next to the counterweight base plate.

12. Mobile crane according to claim 1, wherein two spaced-apart coupling elements are connected to the counterweight base plate and have a flat shape.

13. Counterweight device for a Mobile crane according to claim 1, further comprising at least one counterweight element stackable on the counterweight base plate.

14. Method for assembling the counterweight device on the upper carriage of a mobile crane according to claim 1, having the following steps:
placing the counterweight base plate on a storage area of the undercarriage, by means of a boom of the mobile crane,
lifting the assembly unit including the carrier plate and the suspension weights connected to it via slinging means of the suspension weights,
placing the assembly unit on the counterweight base plate, and
lifting the entire counterweight device via a ballasting device of the mobile crane to the upper carriage, by coupling at least one ballasting cylinder to at least one coupling element connected to the counterweight base plate and projecting through the carrier plate.

15. Method according to the claim 1 wherein the second connections form axes of rotation for the suspension weights and are thus designed such that the suspension weights pivot about the axes of rotation relative to the carrier plate when the assembly unit is lifted and thus spread apart laterally by a defined distance, and where the suspension weights spread apart laterally when the assembly unit is lifted, such that the assembly unit forms a widened receiving area for the counterweight base plate when spread open and can be set down on it, wherein the suspension weights are arranged next to the counterweight base plate during lowering and pivot towards it.

16. Mobile crane according to claim 3, wherein the ballasting device comprises at least one hydraulic ballasting cylinder; and wherein the carrier plate has at least one recess, through which the at least one coupling element protrudes in the deposited state.

17. Mobile crane according to claim 5, wherein the coupling piece can be inserted by rotating the upper carriage about its axis of rotation.

18. Mobile crane according to claim 6, wherein the counterweight plate and the at least one further counterweight element also form a jointly liftable second assembly unit.

19. Mobile crane according to claim 8, wherein the rotary movements are limited by a stop of the first connecting elements.
